(19) United States
(12) Patent Application Publication
(10) Pub. No.: US 2017/0299035 A1
(43) Pub. Date: Oct. 19, 2017

(54) DIFFERENTIAL DEVICE

(71) Applicant: HONDA MOTOR CO., LTD., Tokyo (JP)

(72) Inventor: Shigeharu WAKUI, Wako (JP)

(73) Assignee: HONDA MOTOR CO., LTD., Tokyo (JP)

(21) Appl. No.: 15/489,735

(22) Filed: Apr. 18, 2017

(30) Foreign Application Priority Data
Apr. 18, 2016 (JP) 2016-082909
Apr. 4, 2017 (JP) 2017-074576

(51) Int. Cl. F16H 48/08; F16H 48/38

(52) U.S. Cl. CPC F16H 48/08; F16H 48/38; F16H 2048/385; F16H 2048/087

(57) ABSTRACT

A differential device includes a ring gear having a center axis of the ring gear. A pinion shaft is provided in the ring gear such that a shaft axis of the pinion shaft is substantially perpendicular to the center axis and substantially coaxial with a diameter of the ring gear. The pinion shaft is rotatable together with the ring gear around the center axis. A first attaching member is connected to the ring gear and has a first fitting hole into which a first end portion of the pinion shaft is fitted. A second attaching member is connected to the ring gear and has a second fitting hole into which a second end portion of the pinion shaft is fitted.

### CROSS-REFERENCE TO RELATED APPLICATIONS

The present application claims priority under 35 U.S.C. §119 to Japanese Patent Application No. 2016-082909, filed Apr. 18, 2016, and Japanese Patent Application No. 2017-074576 filed Apr. 4, 2017, entitled “Differential Device.” The contents of these applications are incorporated herein by reference in their entirety.

### BACKGROUND

### 1. Field

The present disclosure relates to a differential device.

### 2. Description of the Related Art

Hitherto, a differential device attached to a transmission (reduction gear) of a vehicle has been available. In order to transmit power that is input to the transmission from a power source, such as an engine or a motor, to a driving wheel, the differential device transmits power that is output from a final drive gear of the transmission to a driving shaft.

In such a differential device, a plurality of gears are disposed in a case, which is a housing, of the differential device. The plurality of gears include two pinion gears and two side gears. The two pinion gears are disposed so as to face each other with a pinion shaft attached to the case being a rotational axis. The two side gears engage the two pinion gears. Each side gear is disposed at a drive shaft that transmits power to the driving wheel (refer to, for example, Japanese Unexamined Patent Application Publication No. 2005-180577 (Patent Literature 1 (PTL 1)).

By virtue of the above-described structure, power that is transmitted to an output side of the transmission is transmitted to the differential device from the final drive gear of the transmission. Here, in PTL 1, power that has been input from a ring gear, which is a final driven gear, of the differential device is transmitted to the case, which is integrated into the ring gear, and to the pinion shaft, which is attached to the case.

Further, a structure in which power is directly transmitted to the pinion shaft from the ring gear, which is a final driven gear, without being transmitted through the case is available (see, for example, Japanese Unexamined Patent Application Publication No. 2012-067822 (Patent Literature 2 (PTL 2)). According to this structure, since the power is not transmitted to the case, the shape of the case is chosen with greater freedom. In PTL 2, a body of the ring gear and the pinion shaft are directly connected to each other.

### SUMMARY

According to one aspect of the present invention, there is provided a differential device including a ring gear that includes a body and outer circumferential teeth, power from a power source being transmitted from the outer circumferential teeth to the body; a pinion shaft that rotates together with the body of the ring gear; a pinion gear that is assembled so as to be rotatable with the pinion shaft as an axis; a plurality of side gears that include rotational axes that are orthogonal to the pinion shaft, and that engage with the pinion gear; and an assembling member that is disposed between the pinion shaft and the body of the ring gear, and that assembles the pinion shaft to the ring gear. The assembling member includes fitting holes to which two end portions of the pinion shaft are fitted. The assembling member is integrated into the body of the ring gear.

According to another aspect of the present invention, a differential device includes a ring gear, a pinion shaft, a first attaching member, a second attaching member, a pinion gear, and a side gear. The ring gear has a center axis of the ring gear and is rotatable around the center axis. The pinion shaft is provided in the ring gear such that a shaft axis of the pinion shaft is substantially perpendicular to the center axis and substantially coaxial with a diameter of the ring gear. The pinion shaft is rotatable together with the ring gear around the center axis. The pinion shaft has a first end portion and a second end portion opposite to the first end portion along the shaft axis. A first attaching member is connected to the ring gear and has a first fitting hole into which the first end portion of the pinion shaft is fitted. A second attaching member is connected to the ring gear and has a second fitting hole into which the second end portion of the pinion shaft is fitted. The pinion gear is provided on the pinion shaft on a side of at least one of the first end portion and the second end portion to be rotatable around the shaft axis. The side gear engages with the pinion gear and is rotatable around the center axis.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a sectional view of the entire differential device.

FIG. 2 is a side sectional view in which some members of the differential device are not shown.

FIG. 3A and FIG. 3B are enlarged sectional views showing the size of a portion of an assembling member that is assembled to a ring gear and/or a portion thereof that is assembled to a pinion shaft, with FIG. 3A being a sectional view of an outer side of the assembling member and FIG. 3B being a sectional view of an inner side of the assembling member.

### DESCRIPTION OF THE EMBODIMENTS

The embodiments will now be described with reference to the accompanying drawings, wherein like reference numerals designate corresponding or identical elements throughout the various drawings.

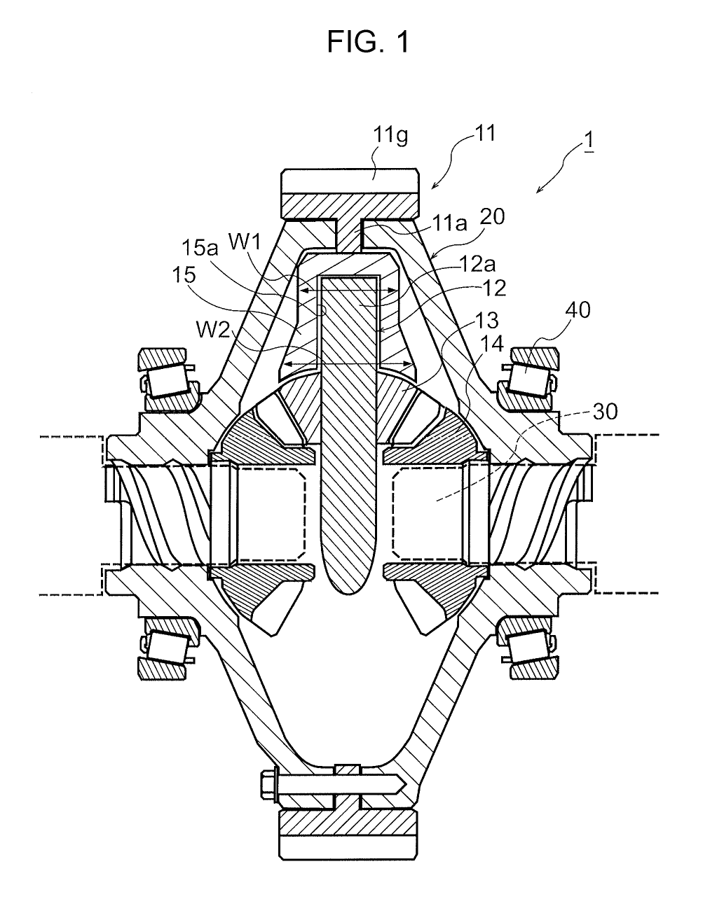

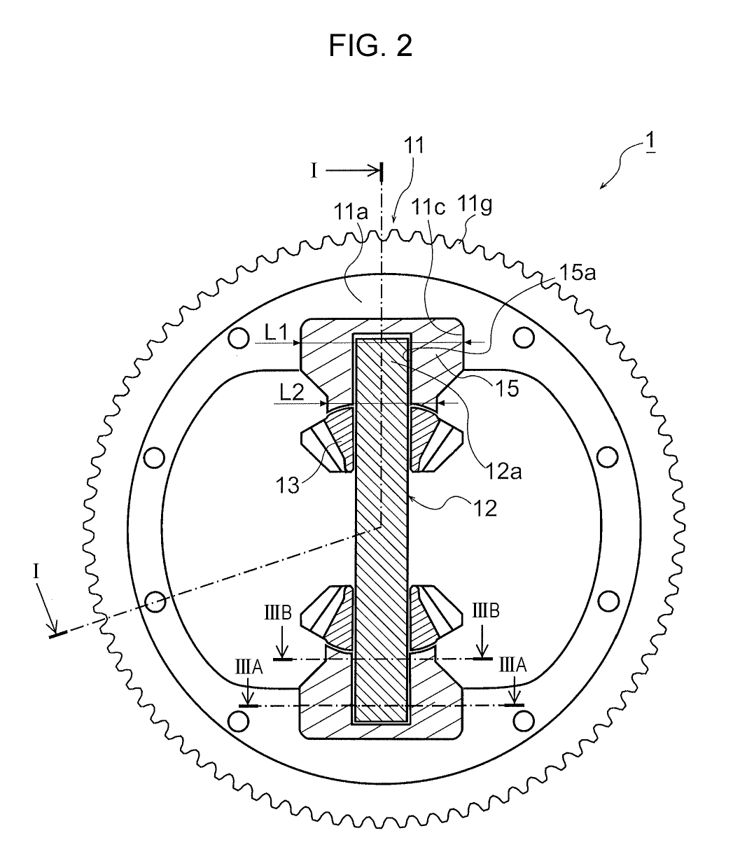

An embodiment is hereunder described in detail with reference to the attached drawings. FIG. 1 is a sectional view of the entire differential device 1. FIG. 2 is a side sectional view in which some members of the differential device 1 are not shown. FIG. 1 is a sectional view taken along line I-I in FIG. 2. In FIG. 2, side gears 14, a case 20, etc., are not shown.

As shown in FIG. 1 and FIG. 2, the differential device 1 includes a ring gear 11, a pinion shaft 12 to which power from the ring gear 11 is transmitted, two pinion gears 13 that rotate with the pinion shaft 12 as an axis, two side gears 14 that engage with the pinion gears 13, and two assembling members 15 (two attaching member 15) that hold two end portions of the pinion shaft 12. The ring gear 11, the pinion shaft 12, the pinion gears 13, the side gears 14, and the assembling members 15 are assembled in a case 20, which is an external housing, of the differential device 1.

By including such members mentioned above, the differential device 1 transmits power that is transmitted from a final drive gear (not shown) to drive shafts 30. In the description below, a portion in which power is transmitted to the pinion shaft 12 from the ring gear 11 through the assembling members 15 is particularly called a power transmitting section. The structure of each member is described in detail below.

The ring gear 11 is a gear to which power from the final drive gear of a transmission (not shown) is transmitted, and includes outer circumferential teeth 11g that are formed on an outer circumferential surface thereof and that receive power from a power source. The power transmitted to the outer circumferential teeth 11g is transmitted to a body 11a of the ring gear 11 at an inner circumferential side of the ring gear 11.

Two end portions 12a of the pinion shaft 12 are fitted to fitting holes 15a in the assembling members 15 (shown in FIG. 2). The assembling members 15 are assembled to the body 11a of the ring gear 11. Therefore, the body 11a of the ring gear 11 and the pinion shaft 12 rotate together via the assembling members 15.

The pinion gears 13 are a pair of gears that are assembled on the pinion shaft 12 so as to be rotatable with the pinion shaft 12 as a rotational axis. The plurality of pinion gears 13 (two pinion gears 13 in the embodiment) are disposed in an axial direction of the pinion shaft 12. The pinion gears 13 slide with respect to the assembling members 15.

As shown in FIG. 1, the side gears 14 have rotational axes that are orthogonal to the pinion shaft 12, and engage with the plurality of pinion gears 13. The two side gears 14 are spline-coupled to the respective left and right drive shafts 30.

As shown in FIG. 1, the case 20 of the differential device 1 covers the body 11a of the ring gear 11. Therefore, the case 20 covers the assembling members 15 that are assembled to the body 11a of the ring gear 11, the pinion shaft 12 whose two end portions are held by the assembling members 15, and outer peripheries of the pair of pinion gears 13 and the pair of side gears 14 to which power at the pinion shaft 12 is transmitted. Since the case 20 is held by bearings 40 with respect to the outside of the device, the case 20 can rotate as the ring gear 11 rotates.

The material of the case 20 may be a light material, such as a light alloy or resin, in addition to generally used metals, such as cast iron. Making the case 20 out of a light material is desirable because this makes it possible to reduce the weight of the entire device. In particular, in the structure in the embodiment, since the power from the ring gear 11 is directly transmitted to the pinion shaft 12, and is not transmitted to the case 20, the strength of the case 20 need not be as high as that which withstands the transmission of power. Therefore, a light material, such as a light alloy or resin, may be used. When a material having a specific gravity that is less than that of iron, which is the material of the ring gear 11, is used in this way, the entire device is made light.

Next, a specific structure of the assembling members 15 according to the embodiment is described. As shown in FIG. 1 and FIG. 2, the assembling members 15 are disposed between the body 11a of the ring gear 11 and the pinion shaft 12. The pinion shaft 12 is held by the two assembling members 15. More specifically, each assembling member 15 has the fitting hole 15a. The two end portions 12a of the pinion shaft 12 are fitted into the corresponding fitting holes 15a. In this way, the two assembling members 15 and the pinion shaft 12 are integrally assembled to each other.

The body 11a of the ring gear 11 is integrated into outer portions of the assembling members 15. More specifically, as shown in FIG. 2, the body 11a of the ring gear 11 has two cutout portions 11c that face each other. The outer portions of the assembling members 15 are fitted into the corresponding cutout portions 11c of the ring gear 11. In this way, the two assembling members 15 are integrally assembled to the ring gear 11. By virtue of this structure, the ring gear 11, the assembling members 15, and the pinion shaft 12 are integrated into each other, and power transmitted to the ring gear 11 is transmitted to the pinion shaft 12 through the assembling members 15.

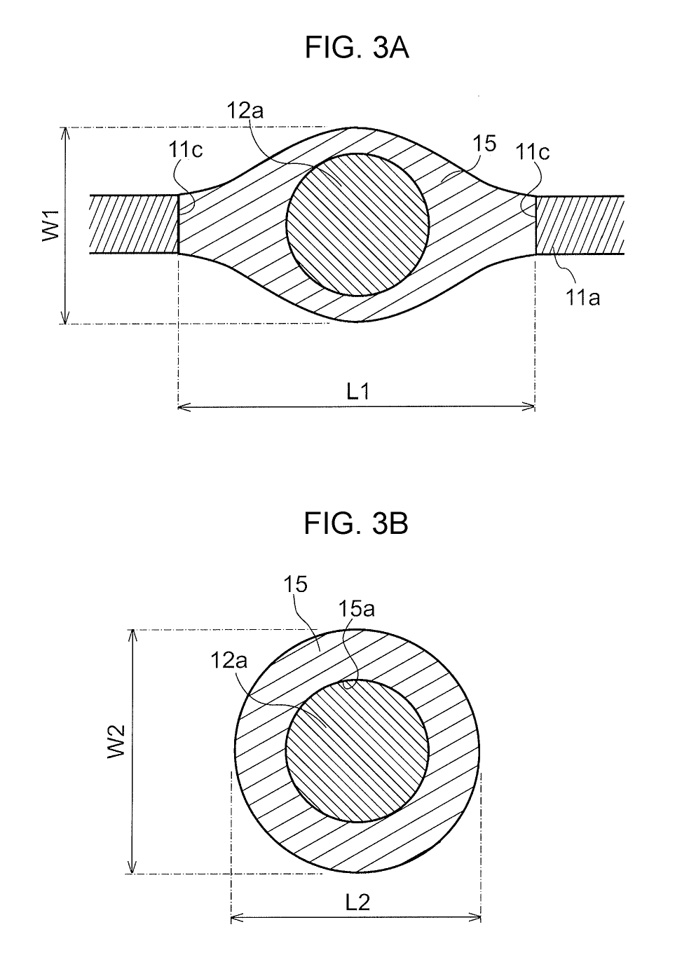

Next, the shape of each assembling member 15 is specifically described with reference to FIG. 3A and FIG. 3B. FIG. 3A and FIG. 3B are enlarged sectional views showing the size of a portion of an assembling member that is assembled to the ring gear and/or a portion thereof that is assembled to the pinion shaft. More specifically, FIG. 3A is a sectional view of an outer side of the assembling member 15 taken along line IIIA-IIIA in FIG. 2. FIG. 3B is a sectional view of an inner side of the assembling member 15 taken along line IIIB-IIIB in FIG. 2.

In a plane that is parallel to the body 11a of the ring gear 11 (that is, a plane extending in a left-right direction in FIG. 3A and FIG. 3B), a width L1 (see FIG. 3A) of an end portion of the assembling member 15 that is assembled to the body 11a is larger than a width L2 (see FIG. 3B) of an end portion of the assembling member 15 at a side of the pinion gears 13. Power obtained by the outer circumferential teeth 11g of the ring gear 11 is transmitted to the assembling members 15 through the cutout portions 11c. When the width L1 of the end portion at the outer side of each assembling member 15 that contacts the corresponding cutout portion 11c is larger than the width L2 of the end portion at the inner side of each assembling member 15, it is possible to increase rigidity.

In a plane that is orthogonal to the body lie of the ring gear 11 (that is, a plane extending in an up-down direction in FIG. 3A and FIG. 3B), a width W2 (see FIG. 3B) of the end portion of the assembling member 15 at the side of the pinion gears 13 is larger than a width W1 (see FIG. 3A) of the end portion of the assembling member 15 that is assembled to the body 11a. While reducing the size of a portion of each assembly member 15 that is situated at the side of the body lie and that is not assembled to the corresponding cutout portion 11c as a result of reducing the width of this portion of each assembling member 15 in this way, surfaces of the assembling members 15 at the side of the pinion gears 13 can be made large, so that they can contact entire contactable surfaces of the pinion gears 13.

As described above, when a structure in which the end portions 12a of the pinion shaft 12 are fitted to the assembling members 15 is used as in the differential device 1 having the above-described structure, it is possible to prevent a reduction in the strength of the pinion shaft 12.

That is, when the body 11a of the ring gear 11 and the pinion shaft 12 are directly assembled to each other, it becomes necessary to process, such as cut, part of the pinion shaft 12, such as cutting out part of the end portions 12a of the pinion shaft 12. In this case, the diameter of the pinion shaft 12 is reduced, as a result of which its strength may be reduced.

In contrast, in the case of the above-described structure, it is not necessary to process the end portions of the pinion shaft 12 and reduce the diameter of the pinion shaft 12. Therefore, the strength of the power transmitting section, which is a portion in which power is transmitted from the body 11a of the ring gear 11 to the pinion shaft 12, is increased.

In the differential device 1 having the above-described structure, the assembling members 15 may be provided at the cutout portions 11c, which are formed by cutting out the body 11a of the ring gear 11. When the assembling members 15 are provided at the cutout portions 11c, which are formed by cutting out the body 11a, in this way, adjustments, such as making the diameter of each assembling member 15 larger than the diameter of the pinion shaft 12, may be made, so that it is possible to make adjustments to increase the strength of each assembling member 15.

In the differential device 1 having the above-described structure, in a plane that is parallel to the body 11a of the ring gear 11, the width L1 of the end portion of each assembling member 15 that is assembled to the body 11a may be made larger than the width L2 of the end portion of each assembling member 15 at the side of the pinion gears 13. When the width L1 of the end portion of each assembling member 15 that is assembled to the body 11a is larger than the width L2 of the end portion of each assembling member 15 at the side of the pinion gears 13 in this way, the strength of each assembling member 15 at the side of the body 11a of the ring gear 11 can be increased.

In the differential device 1 having the above-described structure, in a plane that is orthogonal to the body 11a of the ring gear 11, the width W2 of the end portion of each assembling member 15 at the side of the pinion gears 13 may be larger than the width W1 of the end portion of each assembling member 15 that is assembled to the body 11a. When the width W2 of the end portion of each assembling member 15 at the side of the pinion gears 13 is larger than the width W1 of the end portion of each assembling member 15 that is assembled to the body 11a in this way, the strength of each assembling member 15 at the side of the pinion gears 13 can be increased.

In the differential device 1 having the above-described structure, the specific gravity of the material of each assembling member 15 may be less than the specific gravity of the material of the ring gear 11. When the material of each assembling member 15 is made light in this way, the weight of the entire differential device 1 can be reduced while maintaining its strength.

Although an embodiment of the present disclosure is described, the present disclosure is not limited to the above-described embodiment. Various modifications may be made within the scope of the claims and within the scope of the technical ideas described in the specification and illustrated in the drawings.

Although an embodiment of the present disclosure discloses two pinion gears 13 are assembled on the pinion shaft 12, the present disclosure is not limited to the above-described embodiment. For example, only one pinion gear 13 can be assembled on the pinion shaft 12.

According to an aspect of an embodiment, there is provided a differential device (1) including a ring gear (11) that includes a body (11a) and outer circumferential teeth (11g), power from a power source being transmitted from the outer circumferential teeth (11g) to the body (11a); a pinion shaft (12) that rotates together with the body (11a) of the ring gear (11); a pinion gear (13) that are assembled so as to be rotatable with the pinion shaft (12) as an axis; a plurality of side gears (14) that include rotational axes that are orthogonal to the pinion shaft (12), and that engage with the pinion gear (13); and an assembling member (15) that is disposed between the pinion shaft (12) and the body (11a) of the ring gear (11), and that assembles the pinion shaft (12) to the ring gear (11). The assembling member (15) includes fitting holes (15a) to which two end portions (12a) of the pinion shaft (12) are fitted. The assembling member (15) is integrated into the body (11a) of the ring gear (11).

When a structure in which the end portions (12a) of the pinion shaft (12) are fitted to the assembling member (15) in this way is used, it is possible to prevent a reduction in the strength of the pinion shaft (12). That is, when the body (11a) of the ring gear (11) and the pinion shaft (12) are directly assembled to each other, it becomes necessary to process, such as cut, part of the pinion shaft (12), such as cutting out part of the end portions (12a) of the pinion shaft (12). In this case, the diameter of the pinion shaft (12) is reduced. In contrast, in the case of the above-described structure according to the aspect, it is not necessary to process the end portions of the pinion shaft (12) and reduce the diameter of the pinion shaft (12). Therefore, the strength of the power transmitting section, which is a portion in which power is transmitted from the body (11a) of the ring gear (11) to the pinion shaft (12), is increased.

In the differential device (1) having the above-described structure, the assembling member (15) may be disposed at a cutout portion (11c) of the body (11a) of the ring gear (11). When the assembling member (15) is provided at the cutout portion (11c), which is formed by cutting out the body (11a), in this way, adjustments, such as making the diameter of the assembling member (15) larger than the diameter of the pinion shaft (12), may be made, so that it is possible to make adjustments to increase the strength of the assembling member (15).

In the differential device (1) having the above-described structure, in a plane that is parallel to the body (11a) of the ring gear (11), a width (L1) of an end portion of the assembling member (15) that is assembled to the body (11a) may be larger than a width (L2) of an end portion of the assembling member (15) at a side of the pinion gear (13). When the width (L1) of the end portion of the assembling member (15) that is assembled to the body (11a) is larger than the width (L2) of the end portion of the assembling member (15) at the side of the pinion gear (13) in this way, the strength of the assembling member (15) at the side of the body (11a) of the ring gear (11) can be increased.

In the differential device (1) having the above-described structure, in a plane that is orthogonal to the body (11a) of the ring gear (11), a width (W2) of an end portion of the assembling member (15) at a side of the pinion gear 13 may be larger than a width (W1) of an end portion of the assembling member (15) that is assembled to the body (11a). When the width (W2) of the end portion of the assembling member (15) at the side of the pinion gear (13) is larger than the width (W1) of the end portion of the assembling member (15) that is assembled to the body (11a) in this way, the strength of the assembling member (15) at the side of the pinion gear (13) can be increased.

In the differential device (1) having the above-described structure, a specific gravity of a material of the assembling member (15) may be less than a specific gravity of a material of the ring gear (11). When the material of the assembling member (15) is light, the weight of the entire differential device (1) can be reduced while maintaining its strength.

The symbols in parentheses above correspond to the symbols of structural elements in an embodiment described below. These symbols are merely used as examples in the present disclosure.

According to the present disclosure, it is possible to increase the strength of the power transmitting section in the differential device having a structure in which power is transmitted from the ring gear to the pinion gear without being transmitted through the case.

Obviously, numerous modifications and variations of the present invention are possible in light of the above teachings. It is therefore to be understood that within the scope of the appended claims, the invention may be practiced otherwise than as specifically described herein.

What is claimed is:

1. A differential device comprising:
a ring gear that includes a body and outer circumferential teeth, power from a power source being transmitted from the outer circumferential teeth to the body;
a pinion shaft that rotates together with the body of the ring gear;
a pinion gear that is assembled so as to be rotatable with the pinion shaft as an axis;
a plurality of side gears that include rotational axes that are orthogonal to the pinion shaft, and that engage with the pinion gear; and
an assembling member that is disposed between the pinion shaft and the body of the ring gear, and that assembles the pinion shaft to the ring gear,
wherein the assembling member includes fitting holes to which two end portions of the pinion shaft are fitted, and
wherein the assembling member is integrated into the body of the ring gear.

2. The differential device according to claim 1, wherein the assembling member is disposed at a cutout portion of the body of the ring gear.

3. The differential device according to claim 1, wherein, in a plane that is parallel to the body of the ring gear, a width of an end portion of the assembling member that is assembled to the body is larger than a width of an end portion of the assembling member at a side of the pinion gear.

4. The differential device according to claim 1, wherein, in a plane that is orthogonal to the body of the ring gear, a width of an end portion of the assembling member at a side of the pinion gear is larger than a width of an end portion of the assembling member that is assembled to the body.

5. The differential device according to claim 1, wherein a specific gravity of a material of the assembling member is less than a specific gravity of a material of the ring gear.

6. A differential device comprising:
a ring gear having a center axis of the ring gear and being rotatable around the center axis;
a pinion shaft provided in the ring gear such that a shaft axis of the pinion shaft is substantially perpendicular to the center axis and substantially coaxial with a diameter of the ring gear, the pinion shaft being rotatable together with the ring gear around the center axis, the pinion shaft having a first end portion and a second end portion opposite to the first end portion along the shaft axis;
a first attaching member connected to the ring gear and having a first fitting hole into which the first end portion of the pinion shaft is fitted;
a second attaching member connected to the ring gear and having a second fitting hole into which the second end portion of the pinion shaft is fitted;
a pinion gear provided on the pinion shaft on a side of at least one of the first end portion and the second end portion to be rotatable around the shaft axis; and
a side gear engaging with the pinion gear and being rotatable around the center axis.

7. The differential device according to claim 6, wherein the first attaching member and the second attaching member are disposed at a cutout portion of the ring gear.

8. The differential device according to claim 6, wherein a width of a first portion of each of the first attaching member and the second attaching member which are attached to the ring gear is larger than a width of a second portion of each of the first attaching member and the second attaching member to which the pinion gear is attached, as viewed in the center axis.

9. The differential device according to claim 6, wherein a width of a second portion of each of the first attaching member and the second attaching member to which the pinion gear is attached is larger than a width of a first portion of each of the first attaching member and the second attaching member which is attached to the ring gear.

10. The differential device according to claim 6, wherein a specific gravity of a material of each of the first attaching member and the second attaching member is less than a specific gravity of a material of the ring gear.
